(19) United States
(12) Patent Application Publication
(10) Pub. No.: US 2009/0030152 A1
(43) Pub. Date: Jan. 29, 2009

(54) High Electric Energy Density Polymer Capacitors With Fast Discharge Speed and High Efficiency Based On Unique Poly (Vinylidene Fluoride) Copolymers and Terpolymers as Dielectric Materials

(76) Inventors: Qiming Zhang, State College, PA (US); Baojin Chu, State College, PA (US); Xin Zhou, State College, PA (US); Yingying Lu, State College, PA (US); Qing Wang, State College, PA (US); Bret Neese, State College, PA (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/087,221

(22) PCT Filed: Dec. 18, 2006
(86) PCT No.: PCT/US2006/048258

§ 371 Date: Jun. 27, 2008

Related U.S. Application Data
(60) Provisional application No. 60/754,497, filed on Dec. 28, 2005.

(51) Int. Cl. C08L 27/16

(52) U.S. Cl. 525/199

(57) ABSTRACT

An improved charge or energy storage device having a dielectric charge or energy storage layer including:
(i) a copolymer or terpolymer selected from P(VDF-CTFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE); or
(ii) a polymer blend of PVDF homopolymer with a copolymer selected from P(VDF-CTFE); P(VDF-CFE); P(VDF-HFP); and P(VDF-CDFE); or
(iii) a polymer blend of a PVDF homopolymer with a terpolymer selected from P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE); or
(iv) a polymer blend of copolymer selected from P(VDF-CTFE); P(VDF-CFE); P(VDF-HFP); and P(VDF-CDFE); with a terpolymer selected from P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE).

### BACKGROUND OF THE INVENTION

1. Field of the Invention

The present invention relates generally to a high electric energy density polymer capacitor with fast discharge speed and high efficiency. More particularly, the present invention relates to a high energy density polymer capacitor based on a unique group of PVDF based copolymers and terpolymers.

2. Description of Related Art

The commercial and consumer requirements for compact and more reliable electric power and electronic systems such as hybrid electric vehicles and defibrillators have grown substantially over the past decade. As a result, development of high electric energy and power density capacitor technology has grown to become a major enabling technology.

For a typical parallel plate capacitor, the capacitance C is given by:

C=K∈₀A/t (1)

wherein K is the dielectric constant (relative permittivity), A is the area and t is the thickness of the capacitor, and ∈₀ is a constant (vacuum permittivity, and =8.85×10⁻¹² F/m).

For linear dielectric materials, electric energy density varies according to:

Uₑ=½K∈₀E² (2)

wherein E is the electric field in the capacitor.

Energy densities of nonlinear dielectrics must be derived from the relationship

Uₑ=∫EdD (3)

where D is the electric displacement.

Although ceramic-based dielectric materials usually display very high dielectric constant (i.e., >1,000), the relatively low breakdown field (<50 MV/m) and catastrophic failure in the ceramic capacitors results in a low electric energy density (<1 J/cm³). On the other hand, although conventional polymers show low dielectric constant (<5), the very high breakdown field (>500 MV/m) generates a relatively high energy density. Thus, for instance, biaxially oriented polypropylene (BOPP), even with a dielectric constant of 2.2 (K=2.2), the high breakdown field (˜650 MV/m) produces a maximum electric energy density of more than 4 J/cm³.

In PVDF based polymers, there are different molecular conformations and a reversible change between the polar and non-polar conformations can result in a large polarization change, with the potential to reach a high energy density (see equation (3)). However, the prior art does not teach how to control this polarization change so that the maximum energy density (>20 J/cm³) allowed in this class of polymer can be achieved.

Accordingly, the present invention provides a new class of a modified PVDF polymer, including PVDF based copolymers and terpolymers in which the electric energy density at least 10 J/cm³ can be obtained and there is a possibility of reaching energy density of 30 J/cm³. In addition, these polymer capacitors can be charged and discharged with fast speed (in less than 0.001 seconds) and with high efficiency (more than 85% of the stored electric energy can be discharged to a load). These high energy density polymer capacitors with fast discharge speed and high efficiency will impact on a broad range of power electronics and electric power systems such as these used in the defibrillators, in the hybrid electric vehicles, and in the electric weapons.

### SUMMARY OF THE INVENTION

The present invention provides an improved charge or energy storage device having an organic film as the charge or energy storage layer. The improvement comprising:

a charge or energy storage layer comprising:

(i) a copolymer or terpolymer selected from the group consisting of: P(VDF-CTFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), and P(VDF-TFE-CDFE); or

(ii) a polymer blend of PVDF homopolymer with a copolymer selected from the group consisting of: P(VDF-CTFE); P(VDF-CFE); P(VDF-HFP); and P(VDF-CDFE); or

(iii) a polymer blend of a PVDF homopolymer with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE); or

(iv) a polymer blend of copolymer selected from the group consisting of: P(VDF-CTFE); P(VDF-CFE); P(VDF-HFP); and P(VDF-CDFE); with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE).

The present inventors have discovered that a high electric energy density with fast discharge speed (less than 0.001 seconds) and high efficiency can be achieved in a unique group of polymer capacitor materials, which combine the high breakdown field with improved (matched) dielectric constant, phase stability of the non-polar phase, and large polarization change between non-polar and polar phases.

These copolymers and terpolymers capacitors can be used with a broad range of power electronics including hybrid electric vehicles and defibrillators for storing, controlling, and manipulating electric charge, electric energy, and electric power with high efficiency.

Further objects, features and advantages of the present invention will be understood by reference to the drawings and detailed description that follow.

### BRIEF DESCRIPTION OF THE DRAWINGS

FIG. 1 is a graph depicting discharge energy density of a P(VDF-TrFE-CFE) 62/29/9 mol % terpolymer according to the present invention as a function of the applied electric field.

FIG. 2 is a graph schematically illustrating the relationship between the saturation electric field and electric energy density. For the cases shown in FIG. 2, even though the polymer in “1” has a higher dielectric constant than that in “2”, the lower saturation electric field in “1” leads to a lower energy density.

FIGS. 3(a)-(c) are graphs having charging and discharging curves measured using a Sawyer-Tower circuit at 10 Hz for (a) unstretched PVDF, (b) uniaxially stretched PVDF, and (c) uniaxially stretched P(VDF-CTFE) at 15 wt % CTFE.

FIG. 4 is a graph depicting discharged energy density of unstrectched PVDF, uniaxially stretched PVDF homopolymer as a function of electric field.

FIG. 5 is a graph depicting discharged energy density of unstrectched P(VDF-CTFE), uniaxially stretched P(VDF-CTFE) at 15 wt % CTFE as a function of electric field.

FIG. 6(a) is a graph depicting charging and discharging data for a uniaxially stretched P(VDF-HFP) 90/10 wt %.

FIG. 6(b) is a graph depicting the corresponding discharged energy density at different applied field levels.

FIG. 7 is a graph depicting discharging data of P(VDF-CTFE) 85/15 wet % under a field of 347 MV/m to a 100 kohm resistor load, wherein the capacitance of the copolymer sample is at 0.5 nF.

### DETAILED DESCRIPTION OF THE PREFERRED EMBODIMENTS

The present invention provides a device for storing, and/or controlling, and/or manipulating of charge and/or electric energy having a polymer film as the dielectric layer, such as, a capacitor.

The polymer thin film can be copolymer or terpolymer selected from P(VDF-CTFE), P(VDF-CFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), P(VDF-TFE-CDFE) is provided, wherein:

CTFE: chlorotrifluoroethylene;

CFE: chlorofluoroethylene;

HFP: hexafluoropropylene;

CDFE: chlorodifluoroethylene;

TrFE: trifluoroethylene; and

TFE: tetrafluoroethylene.

The mol % of CTFE, or CFE, or HFP, or CDFE in the copolymers and terpolymers is in the range between 0 mol % and 10 mol %.

The mol % of TrFE or TFE in the terpolymers is in the range between 0 mol % and 15 mol %.

Also provided is a polymer blend of PVDF homopolymer with a copolymer selected from the group consisting of: P(VDF-CTFE); P(VDF-CFE); P(VDF-HFP); and P(VDF-CDFE) or a polymer blend of a PVDF homopolymer with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE), including, for example, polymer blends with either a PVDF homopolymer or a copolymer and a terpolymer. The copolymer is selected from one of the following:

P(VDF-CTFE);

P(VDF-CFE);

P(VDF-HFP); and

P(VDF-CDFE).

Additionally provided is a polymer blend of copolymer selected from the group consisting of: P(VDF-CTFE); P(VDF-CFE); P(VDF-HFP); and P(VDF-CDFE); with a terpolymer selected from the group consisting of: P(VDF-TrFE-CTFE); P(VDF-TrFE-CFE); P(VDF-TrFE-HFP); P(VDF-TrFE-CDFE); P(VDF-TFE-CTFE); P(VDF-TFE-CFE); P(VDF-TFE-HFP); and P(VDF-TFE-CDFE). The terpolymer is selected from the following:

P(VDF-TrFE-CTFE);

P(VDF-TrFE-CFE);

P(VDF-TrFE-HFP);

P(VDF-TrFE-CDFE);

P(VDF-TFE-CTFE);

P(VDF-TFE-CFE);

P(VDF-TFE-HFP); and

P(VDF-TFE-CDFE).

The composition for the copolymer in a blend of PVDF homopolymer or a copolymer and a terpolymer is at CTFE or CFE or HFP or CDFE in the range of 0 mol % to 10 mol % and the terpolymer is at TrFE or TFE mol % in the range from 20 mol % to 40 mol % and at CTFE, or CFE, or HFP, or CDFE in the range of 3 to 10 mol %.

The copolymer, terpolymer, and blends of PVDF homopolymer or a copolymer and a terpolymer films are uniaxially stretched to a drawing ratio from 0× to 8× (zero times to 8 times) of the original length.

The copolymer, terpolymer, and blends of PVDF homopolymer or a copolymer and a terpolymer films are biaxially stretched to a stretching ratio from 0× to 5× of the original length.

The stored electric energy density of these copolymer and terpolymer films at least about 10 J/cm³ under an electric field higher than 450 MV/m, preferably between about 12 to about 30 J/cm³ under an electric field higher than 450 MV/m, and more preferably between about 12 to about 22 J/cm³ under an electric field higher than 450 MV/m.

The discharge time (release of 90% of the stored energy) of a polymer thin film capacitor (˜0.11 μF) to a 1 kohm load should be less than 1 ms.

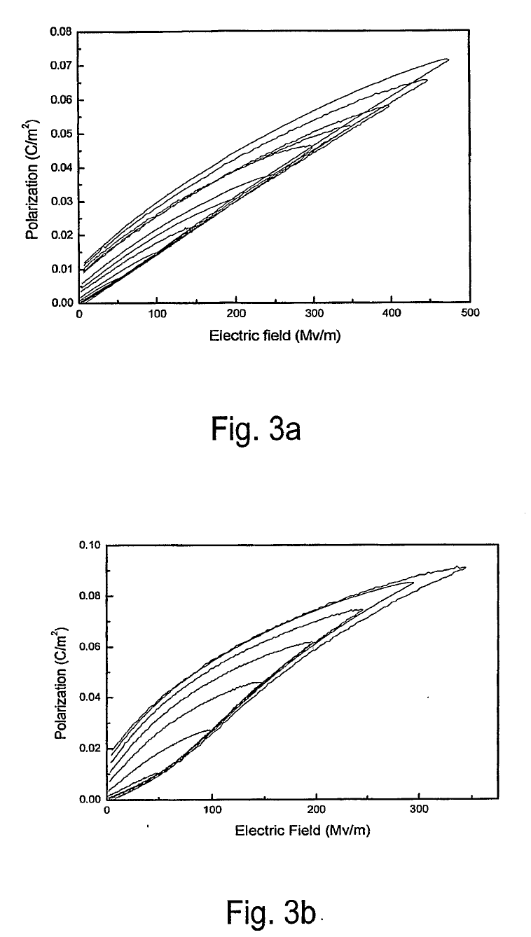

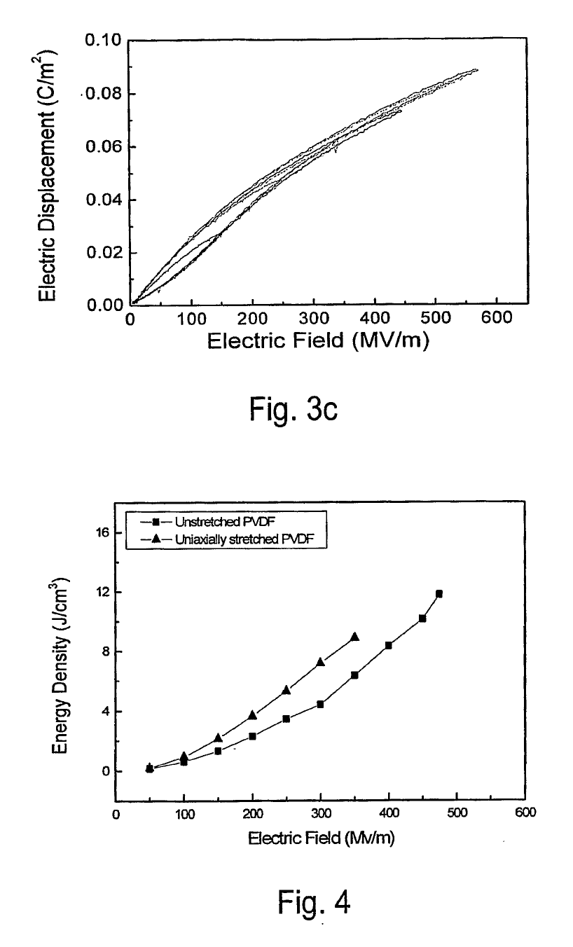

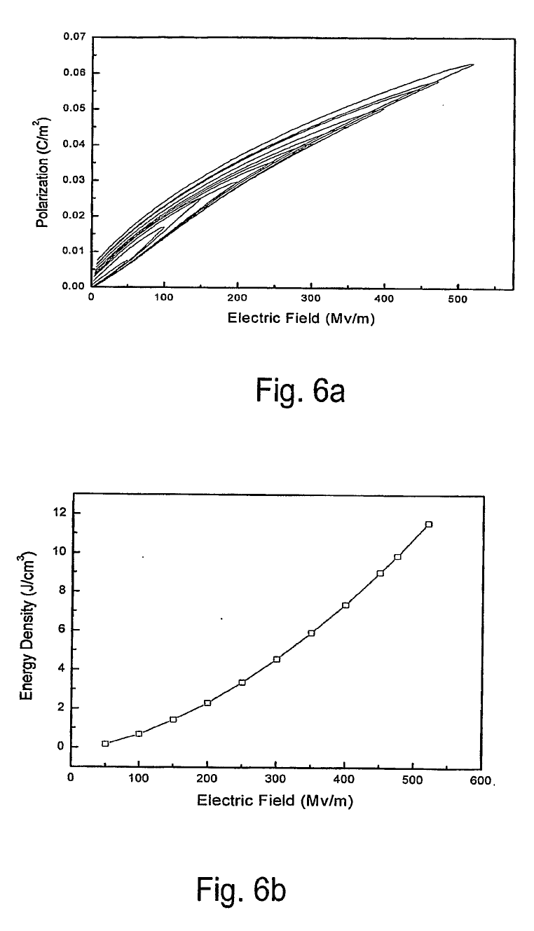

The discharge efficiency, as defined by the ratio of the discharged energy density to the stored energy density (which can be directly derived from FIG. 3 and FIG. 6 using equation 3), should be better than 85% for 1 ms discharge time.

The polymer possesses a stable non-polar phase after the uniaxial drawing of the film to more than 5× or application of electric field of higher than 400 MV/m at temperatures above 50° C.

The present inventors have discovered based on molecular structure consideration and dielectric constant/electric polarization/saturation electric field relationship that a high electric energy density with high discharge efficiency and fast discharge time can be achieved with a unique class of polymer capacitor materials, which combine the high breakdown field with improved (marched) dielectric constant and phase stability of the non-polar phase.

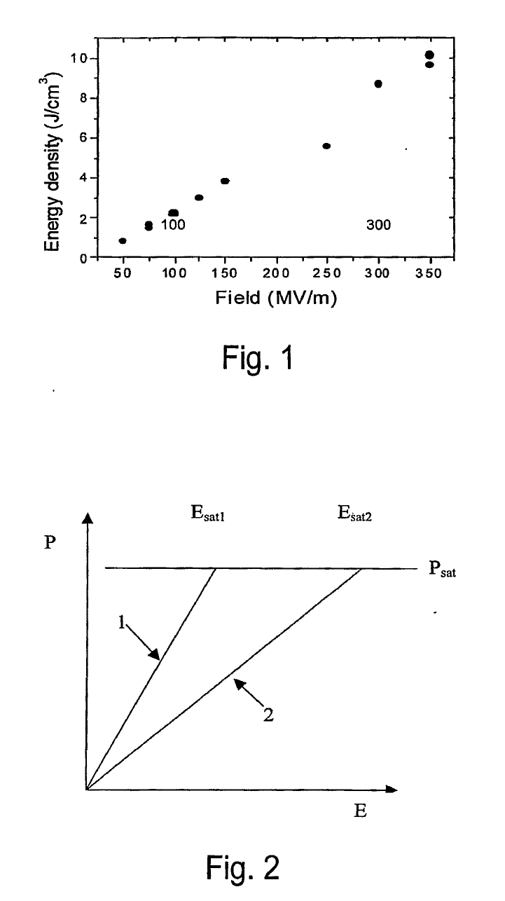

For example, in recently developed relaxor ferroelectric polymers, i.e., poly(vinylidene-fluoride/trifluoroethylene) (P(VDF-TrFE)) based terpolymers and high energy electron irradiated P(VDF-TrFE) copolymers, a room temperature dielectric constant of higher than 50 has been achieved. Consequently, under a field of 350 MV/m, an electric energy density of 10 J/cm³ can be obtained (see FIG. 1).

On the other hand, due to the nonlinear dielectric behavior, the relaxor ferroelectric polymers show polarization saturation (as indicated by a reduction of the effective dielectric constant with applied field amplitude), which limits the further increase of the electric energy density to far beyond 10 J/cm³ level.

In PVDF based polymers, there are different molecular conformations and a reversible change between the polar and non-polar conformations can result in a large polarization change, with the potential to reach a high energy density as suggested by equation (3). However, the prior art does not teach how to control this polarization change so that the maximum energy density allowed in this class of polymer can be achieved.

Accordingly, the present invention provides a new class of a modified PVDF polymer, including PVDF based copolymers and terpolymers in which the energy density at least 10 J/cm³ can be obtained and there is a possibility of reaching energy density of 30 J/cm³.

These high energy density polymer capacitor materials will impact on a broad range of power electronics and electric power systems such as these used in the hybrid electric vehicles and in the defibrillators.

In all the dielectric materials, there exists a polarization saturation, that is, the polarization level can't be increased further even applying higher electric fields (see FIG. 2). For PVDF based polymers, the highest polarization can be reached is about 0.1 C/m² and the breakdown field can be more than 600 MV/m. If the polarization saturation occurs at 500 MV/m, the energy density, following FIG. 2, will reach 25 J/cm³. If the polarization saturation occurs at 600 MV/m, the energy density, following FIG. 2, will further reach 30 J/cm³.

For such a dielectric materials, the dielectric constant is 20, lower than the relaxor ferroelectric polymer (K>50). This analysis indicates that to achieve higher energy density in PVDF based polymers, a dielectric constant near 20 would be preferred.

In PVDF homopolymers, the room temperature dielectric constant can reach 12 and a breakdown field of higher than 500 MV/m has been shown, indicating a potential to achieve an electric energy density ˜15 J/cm³. If PVDF polymer can maintain its nonpolar phase (the α-phase) after applying a high electric field, the material would be attractive for the high energy density capacitors. However, many earlier studies have shown that the α-phase of PVDF polymer will be gradually converted to the β-phase under high electric field (˜500 MV/m).

Stretching PVDF films can also result in a α-to-β phase conversion. In the β-phase, the energy density of the polymer is much lower due to the remanent polarization. In addition, the dielectric loss will increase due to the presence of the ferroelectric phase. In this sense, PVDF homopolymer is not an ideal dielectric material for the high energy capacitors.

Shown in FIGS. 3(a), 3(b) and 4 is the discharged energy density of PVDF versus the applied field E. Although an energy density of higher than 10 J/cm³ can be reached, there are indications that the polarization switching process is also accompanied by the α-to-β phase conversion (relative large polarization hysteresis), which is not desirable and suitable for long term practical and reliable use in various electric and electronic systems.

On the other hand, by introducing small amount of another monomer into the PVDF polymer to expand the inter-chain space and break-up the dipole coherence in the polymer, the α-phase will be favored and stabilized even under mechanical stretching. After the application of very high electric field (>500 MV/m), the polymer can still return to the nonpolar phase, which is distinctively different from the PVDF homopolymer.

These considerations indicate that a few PVDF copolymers with bulky co-monomers such as chlorotrifluoroethylene (CTFE), chlorofluoroethylene (CFE), and hexafluoropropylene (HFP), and other similar monomers, have the potential to achieve high electric energy density.

Furthermore, by stretching the copolymers such as P(VDF-CTFE), P(VDF-HFP), and P(VDF-CFE), the polymer chain directions are aligned to perpendicular to the applied field so that the polarization level can be increased and consequently the higher energy density may be obtained.

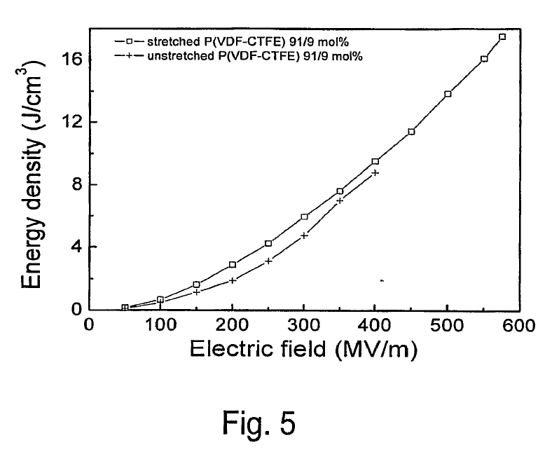

As shown in FIG. 3(c) and FIG. 5, for an uniaxially stretched P(VDF-CTFE) 85/15 wt % copolymer, the breakdown field can reach more than 570 MV/m and an energy density of 17 J/cm³ can be obtained. The dielectric constant of this stretched copolymer at low electric field is about 15.

Shown in FIG. 6 is the energy density data for a uniaxially stretched P(VDF-HFP) 90/10 wt % copolymer. The breakdown field is 525 M/m and an energy density of near 12 J/cm³ is achieved. It is also observed that by either uniaxially or biaxially stretching these films, the electric breakdown field can be increased.

The data in FIGS. 5 and 6 also reveal that even at the highest field level, the polarization of these polymers is not saturated. In other words, the saturation polarization of these polymers is higher than 0.09 C/m². For example, in FIG. 3, extrapolating the polarization to 0.1 C/m² and the field to 650 MV/m, an electric energy density of 24 J/cm³ can be achieved. On the other hand, one can also increase the dielectric constant so that the saturation of 0.1 C/m² is reached at 500 MV/m or 550 MV/m, a lower field than 650 MV/m. Consequently, smaller energy density will be obtained (˜20 J/cm³).

For the P(VDF-CTFE) copolymer and other similar ones (where the 2^{nd} monomer is bulkier in size than VDF to expand the inter-chain space, and favoring the TGTG′ conformation), one can introduce small amount of TrFE to raise the dielectric constant of these polymers, the mol % of TrFE can be in the amount 10 mol % or less. In addition, polymer blends of P(VDF-CTFE) or similar copolymer with the relaxor ferroelectric terpolymer of P(VDF-TrFE-CFE) (CFE: chlorofluoroethylene) and similar terpolymers can also lead to higher energy density.

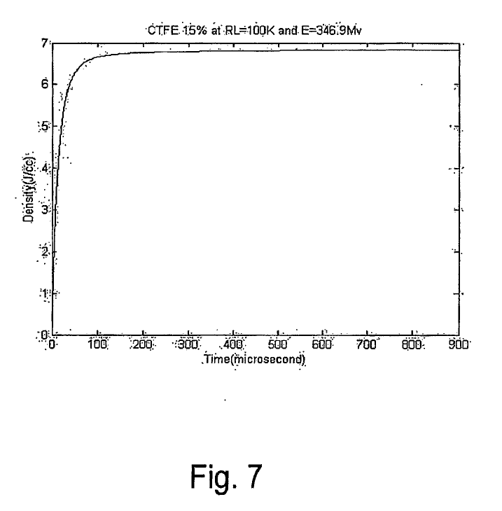

FIG. 7 shows the discharge data of the P(VDF-CTFE) 85/15 wt % copolymer into a 100 kohm load. As can be seen, the stored electric energy can be released within very short time (less than 0.1 ms) which demonstrates that this class of high energy density capacitor can be operated to frequencies higher than 10 kHz.

A variety of PVDF based copolymers are commercially available. For example, P(VDF-CTFE) and P(VDF-HFP) can be purchased from Solvay, Arkema, and 3M. Other copolymers that are not commercially available can be synthesized using the suspension polymerization methods.

Thus, P(VDF-CFE), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), P(VDF-TFE-CDFE) can be synthesized using a suspension polymerization process using an oxygen-activated initiator.

The polymer blends can be fabricated by one of several methods, either by solution blending methods, melt method, extrusion method, or by any other convenient method which can blend the two polymers into a blend.

Thus, in the first step, each polymer used in the blend is synthesized or purchased from a commercial source.

In the solution method, the polymers with proper weight ratios are dissolved in a solvent such as methyl ethyl ketone or any suitable solvent that can dissolve the two polymers. The solution is then poured onto a glass plate and, after the evaporation of the solvent, a polymer film is formed. Alternatively, tape casting method can be used.

In the melt method, the two polymers in a proper wt % ratio are heated at near or above the melting temperatures of both polymers to obtain a uniform melt and thereafter, the melt is pressed under a stress to form a polymer film.

In the extrusion method, the two polymers in a proper wt % ratio are fed to the extruder to be processed to form a polymer film.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

1-18. (canceled)

19. In a device for storing, and/or controlling, and/or manipulating
of charge and/or electric energy having a polymer film as the dielectric layer, the improvement comprising:
a dielectric layer comprising:
(i) a copolymer or terpolymer selected from the group consisting of:
poly(vinylidene-fluoride/chlorotrifluoroethylene, poly(vinylidene-fluoride/chlorofluoriethylene, poly(vinylidene-fluoride/hexafluoropropylene, poly(vinylidene-fluoride/chlorodifluoroethylene, poly(vinylidene-fluoride/trifluoroethylene/chlorotrifluoroethylene, poly(vinylidene-fluoride/trifluoroethylene/chlorofluoroethylene, poly(vinylidene-fluoride/trifluoroethylene/chlorodifluoroethylene, poly(vinylidene-fluoride/trifluoroethylene/chlorotrifluoroethylene, poly(vinylidene-fluoride/trifluoroethylene/chlorofluoroethylene, poly(vinylidene-fluoride/trifluoroethylene/hexafluoropropylene, and poly(vinylidene-fluoride/trifluoroethylene/chlorodifluoroethylene; or
(ii) a polymer blend of poly(vinylidene fluoride) homopolymer with a copolymer selected from the group consisting of:
poly(vinylidene-fluoride/chlorotrifluoroethylene; poly(vinylidene-fluoride/chlorofluoriethylene; poly(vinylidene-fluoride/hexafluoropropylene; and poly(vinylidene-fluoride/chlorodifluoroethylene; or
(iii) a polymer blend of a poly(vinylidene fluoride) homopolymer with a terpolymer selected from the group consisting of:
poly(vinylidene-fluoride/trifluoroethylene/chlorotrifluoroethylene; poly(vinylidene-fluoride/trifluoroethylene/chlorofluoroethylene; poly(vinylidene-fluoride/trifluoroethylene/chlorodifluoroethylene; poly(vinylidene-fluoride/trifluoroethylene/chlorotrifluoroethylene; poly(vinylidene-fluoride/trifluoroethylene/chlorofluoroethylene; poly(vinylidene-fluoride/trifluoroethylene/hexafluoropropylene; and poly(vinylidene-fluoride/trifluoroethylene/chlorodifluoroethylene; or
(iv) a polymer blend of copolymer selected from the group consisting of: poly(vinylidene-fluoride/chlorotrifluoroethylene, poly(vinylidene-fluoride/chlorofluoriethylene, poly(vinylidene-fluoride/hexafluoropropylene, and poly(vinylidene-fluoride/chlorodifluoroethylene; with a terpolymer selected from the group consisting of: poly(vinylidene-fluoride/trifluoroethylene/chlorotrifluoroethylene; poly(vinylidene-fluoride/trifluoroethylene/chlorofluoroethylene; poly(vinylidene-fluoride/trifluoroethylene/chlorodifluoroethylene; poly(vinylidene-fluoride/trifluoroethylene/chlorotrifluoroethylene; poly(vinylidene-fluoride/trifluoroethylene/chlorofluoroethylene; poly(vinylidene-fluoride/trifluoroethylene/hexafluoropropylene; and poly(vinylidene-fluoride/trifluoroethylene/chlorodifluoroethylene.

20. The device of claim 19, wherein mol % of chlorotrifluoroethylene, or chlorofluoroethylene, or hexafluoropropylene, or chlorodifluoroethylene in the copolymers and terpolymers is in the range from 0 mol % to about 10 mol %.

21. The device of claim 19, wherein the mol % of trifluoroethylene or tetrafluoroethylene in the terpolymers is in the range from 0 mol % to about 15 mol %.

22. The device of claim 19, wherein the composition of the copolymer in the blend of poly(vinylidene fluoride homopolymer with a copolymer or terpolymer in chlorotrifluoroethylene or chlorofluoroethylene or hexafluoropropylene or chlorodifluoroethylene is in the range of from 0 mol % to about 10 mol % and wherein the terpolymer in trifluoroethylene or tetrafluoroethylene mol % is in the range from 20 mol % to 40 mol % and wherein chlorotrifluoroethylene, or chlorofluoroethylene, or hexafluoropropylene, or chlorodifluoroethylene is in the range of 3 to 10 mol %.

23. The device of claim 19, wherein the copolymer, terpolymer, and the blends of poly(vinylidene fluoride) homopolymer or the copolymer and the terpolymer films are uniaxially stretched to a drawing ratio from 0× to 8× (zero times to 8 times) of the original length.

24. The device of claim 19, wherein the copolymer, terpolymer, and the blends of poly(vinylidene fluoride) homopolymer or the copolymer and the terpolymer films are biaxially stretched to a stretching ratio from 0× to 5× of the original length.

25. The device of claim 19, wherein the stored electric energy density of the copolymer and terpolymer films is at least about 10 J/cm³ under an electric field higher than 450 MV/m.

26. The device of claim 25, wherein the stored electric energy density of the copolymer and terpolymer films is from about 10 to about 30 J/cm³ under an electric field higher than 450 MV/m.

27. The device of claim 26, wherein the stored electric energy density of the copolymer and terpolymer films is from about 10 to about 20 J/cm³ under an electric field higher than 450 MV/m.

28. The device of claim 19, wherein the charge or energy storage dielectric layer is polymer thin film capacitor.

29. The device of claim 28, wherein discharge time for release of 90% of the stored energy of the polymer thin film capacitor (−0.1˜IF) to a 1 kHz load is less than 1 ms.

30. The device of claim 28, wherein discharge efficiency is higher than 85%.

31. The device of claim 19, wherein the polymer produces an energy density at least about 10 J/cm³ to about 30 J/cm³.

32. The device of claim 19, wherein the polymer has a polarization higher than 0.08 C/m² at a breakdown field higher than 500 MV/m.

33. The device of claim 19, having a multilayer polymer dielectric layer.

34. The device of claim 19, wherein the device is a capacitor.

35. The device of claim 19, wherein the device is a Field Effect Transistor (FET).
